(19) United States
(12) Patent Application Publication
(10) Pub. No.: US 2024/0139715 A1
(43) Pub. Date: May 2, 2024

(54) FIBER-BASED BED GRADING MATERIAL

(71) Applicant: UNIFRAX I LLC, Tonawanda, NY (US)

(72) Inventors: Kevin E. SITERS, Cheektowaga, NY (US); Chih-Han LIU, Cheektowaga, NY (US); Ran W. RIOUX, Amherst, NY (US)

(21) Appl. No.: 18/503,316

(22) Filed: Nov. 7, 2023

Related U.S. Application Data
(63) Continuation of application No. PCT/US2023/077843, filed on Oct. 26, 2023.
(60) Provisional application No. 63/380,955, filed on Oct. 26, 2022.

(51) Int. Cl. B01J 21/04; B01J 21/08; B01J 35/00; B01J 35/10; B01J 37/00; B01J 37/02

(52) U.S. Cl. CPC B01J 21/04; B01J 21/08; B01J 35/0026; B01J 35/1014; B01J 35/1019; B01J 35/1038; B01J 37/0018; B01J 37/0215

(57) ABSTRACT

A bed grading material includes fibers, a hardening agent, and a binder. The fibers include alumina, and the bed grading material may include a catalyst. The bed grading material can include a mixture of different fibers and can be vacuum formed, pressed, wet-laid, extruded, or 3D printed. The bed grading material may be beneficially incorporated into a reactor.

### CROSS-REFERENCE TO RELATED APPLICATIONS

This application is a continuation of PCT International Application No. PCT/US2023/077843, filed Oct. 26, 2023, which claims priority to U.S. Provisional Application No. 63/380,955 filed Oct. 26, 2022, entitled “Fiber-Based Bed Grading Material,” the disclosures of which are hereby incorporated by reference in their entirety.

### FIELD OF THE DISCLOSURE

The present disclosure relates to materials including fiber compositions for use in industrial processes such as waste gas treatment and hydrotreating. More particularly, the disclosure is related to fiber-based bed grading materials for use in industrial reactors.

### BACKGROUND

Industrial catalyst beds may be used for a variety of reactions, such as waste gas treatment, hydrogenation, dehydrogenation, hydrodesulphurization, steam reformation, and the like. These catalyst beds use catalysts, such as platinum group metals (PGM), which can be very expensive and are prone to fouling by components in the treatment stream (“catalyst poisons”) such as arsenic, phosphates, nitro and nitrogen containing species, silicon, cyanides, sulfides, scale, various transition metals including vanadium and nickel and other active organic heterocycles and molecules. If these catalyst poisons are allowed to contact a PGM catalyst in the reactor, the catalyst poisons can bind to the PGM and render it inactive.

As such, bed grading materials are used at a front end of industrial reactors in order to capture the catalyst poisons. Typical bed grading materials include high alumina that is milled and shaped to create active surface area for capture of said materials. However, these materials do not have internal porosity extensive surface area and therefore have limited effectiveness. Additionally, some bed grading materials include a catalyst supported thereon (“active bed grading”) to improve the efficiency of the reactor. The activity of the catalyst is crucial to preventing deactivation of the catalyst responsible for the primary reaction through coking or a buildup of organic material. Traditional materials require a wash coating process to apply the catalyst, wherein the wash coating requires multiple steps such as drying and calcining and yields a weak adhesion of the catalyst. Weak catalyst adhesion and the subsequent buildup of contaminants result in poor reactor performance that can lead to increased downtime of the system and catalyst changeouts. Additionally, use of fibrous material allows for greater interaction of the feedstock with the active component, resulting in improved performance.

### BRIEF DESCRIPTION OF THE DRAWINGS

Various embodiments of the present disclosure will be understood more fully from the detailed description given below and from the accompanying drawings. In the drawings, like reference numbers may indicate identical or functionally similar elements. Embodiments are described in detail hereinafter with reference to the accompanying figures, in which:

FIG. 1 is a perspective view of a bed grading material according to an embodiment of the present disclosure.

FIG. 2 is a top view of the bed grading material of FIG. 1.

FIG. 3 is a perspective view of a bed grading material according to an embodiment of the present disclosure.

FIG. 4 is a top view of the bed grading material of FIG. 3.

FIG. 5 is a diagrammatic illustration of a reactor according to an embodiment of the present disclosure.

FIG. 6 is a graph showing mercury intrusion porosity measurements of Sample 2 of Example 2.

FIG. 7 is an XRD graph of Sample 2 of Example 2.

FIG. 8 is an XRD graph of Comparative Sample 1 of Example 2.

### DETAILED DESCRIPTION

The following disclosure provides many different embodiments or examples. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Provided by the present disclosure is a bed grading material comprising a plurality of fibers, a binder, and a hardening agent. The bed grading material is a shaped material having an internal porosity.

Fibers that are useful in the bed grading material include those described in U.S. Patent Application Publication No. 2019/0309455A1, which is hereby incorporated by reference in its entirety. In some embodiments, the bed grading material comprises greater than 0 to 90 wt %, 5 to 85 wt %, 20 to 75 wt %, 30 to 65 wt %, at least 30 wt %, at least 40 wt %, at least 50 wt %, at least 60 wt %, or at least 70 wt % of fibers based on a total weight of the bed grading material.

In some embodiments, the bed grading material comprises a plurality of different fibers. In some embodiments, the bed grading material comprises at least a first fiber and a second fiber. In some embodiments, the first fiber has a diameter (average diameter) of less than 9 microns, less than 6 microns, less than 5 microns, 1 to 5.5 microns, 1 to 5 microns, 2 to 5 microns, 2 to 4 microns, or about 4 microns. In some embodiments, the first fiber has a surface area of at least 50 m²/g, at least 80 m²/g, at least 100 m²/g, at least 120 m²/g, 50 to 200 m²/g, 100 to 150 m²/g, or about 120 m²/g. In some embodiments, the first fiber consists of γ- and translational alumina. In some embodiments, the first fibers comprise less than 90 wt %, less than 80 wt %, less than 70 wt %, less than 60 wt %, less than 50 wt %, less than 40 wt %, less than 30 wt %, less than 20 wt %, or less than 10 wt % crystalline material with the balance being amorphous. In some embodiments, the first fiber is a ceramic fiber, such as alumino-silicate fibers. In some embodiments, the ceramic fiber may be any of those disclosed in U.S. Patent Application Publication No. 2017/0341004, which is hereby incorporated by reference in its entirety. For example, alumino-silicate fibers may comprise from about 40 to about 60 wt %, about 30 to about 70 wt %, about 30 wt %, about 95 wt %, or about 45 to 51 wt % alumina and from about 60 to about 40 wt %, about 70 to 30 wt %, about 70 wt %, about 5 wt %, or about 46 to about 52 wt % silica. In some embodiments, the ceramic fiber comprises an alumino-silica-magnesia fiber comprising about 64 to about 66 wt % silica, from about 24 to about 25 wt % alumina, and from about 9 to about 10 wt % magnesia.

The second fiber may have a composition that is the same or different from the first fiber. Suitable second fiber compositions include those described above. In some embodiments, the second fiber has a diameter of at least 5 microns, at least 6 microns, at least 7 microns, 5-15 microns, or about 6 microns. In some embodiments, the second fiber has a surface area of at most 40 m²/g, at most 30 m²/g, at most 20 m²/g, at most 10 m²/g, at most 5 m²/g, or about 1 m²/g. In some embodiments, the second fiber consists of fully calcined α-alumina.

In some embodiments, the first fiber and the second fiber differ in at least one of composition, fiber diameter, or surface area. In some embodiments, the first fiber and the second fiber differ in at least two of composition, fiber diameter, or surface area. In some embodiments, the first fiber and the second fiber differ in composition, fiber diameter, and surface area. In some embodiments, the first fiber has a smaller diameter than the second fiber. In some embodiments, the first fiber has a higher surface area than the second fiber.

In some embodiments, the first fiber and the second fiber have the same composition but different fiber diameters and/or different surface areas. In some embodiments, the first fiber and the second fiber have the same fiber diameter but different compositions and/or different surface areas. In some embodiments, the first fiber and the second fiber have the same surface area but different compositions and/or different fiber diameters.

In some embodiments, a weight ratio of the first fiber to the second fiber is from 1:10 to 20:1, from 1:5 to 5:1, from 1:1 to 10:1, from 2:1 to 20:1, or from 2:1 to 10:1. In some embodiments, the fibers in the bed grading material consist of the first fiber or consist of the second fiber.

In some embodiments, the binder includes organic binders such as starch or cellulose and/or inorganic binders such as alumina, zirconia, titania, zinc, magnesia or combinations thereof. In some embodiments, the binder includes starch, cellulose, latex, polyvinyl chloride, an alcohol, an acrylamide, natural resins, synthetic resins, or combinations thereof. In some embodiments, the binder is included in the bed grading material in an amount of 5 to 25 wt %, 5 to 15 wt %, about 5 wt %, about 10 wt %, about 15 wt %, or about 20 wt %.

In some embodiments, the fibers of the bed grading material comprise from greater than 0 to 85 wt %, from greater than 0 to 50 wt %, or from 5 to 50 wt % silica, based on a total weight of the fibers of the bed grading material.

In some embodiments, the bed grading material comprises the hardening agent in an amount of at least 15 wt %, at least 25 wt %, at least 30 wt %, or greater than 20 to 85 wt %, based on a total weight of the bed grading material. In some embodiments, the hardening agent comprises colloidal metal oxides, wherein the metal oxide is silica, alumina, titania, zinc oxide, magnesia, zirconia, or combinations thereof. In some embodiments, the hardening agent comprises colloidal alumina. In some embodiments, the hardening agent is colloidal silica, which may be a stabilized colloidal silica (e.g., ammonia-, sodium-, cation-, or anion-stabilized). In such embodiments, the bed grading material may comprise a total amount of silica (from all sources, i.e., fiber and hardening agent) in an amount of 10 to 85 wt %, 15 to 40 wt %, 15 to 30 wt %, about 10 wt %, about 15 wt %, about 20 wt %, or about 25 wt %, based on a total weight of the bed grading material.

In some embodiments, the bed grading material may include additives and/or fillers, such as a catalyst, colloidal alumina (or other surface area increasing agent), capturing agents (such as CO2 capturing agents), denitrification agents, sorbents for cadmium or lead or arsenic, or combinations thereof. In some embodiments, the catalyst may include copper, zinc, iron, nickel, molybdenum, oxides thereof, other transitions metals or transition metal oxides, or combinations thereof. In some embodiments, the additives may be included during the formation of the bed grading material (e.g., added to a slurry) or may be coated onto the formed bed grading material. In some embodiments, one or more additives may be incorporated into the fibers of the bed grading material. In some embodiments, the total amount of additives may be included in the bed grading material in an amount of from greater than 0 to 50 wt %, greater than 0 to 40 wt %, 5 to 50 wt %, or 10 to 30 wt %.

In some embodiments, the bed grading material has a surface area of about 1 m²/g, at least 1 m²/g, at least 2 m²/g, at least 5 m²/g, at least 10 m²/g, at least 20 m²/g, at least 50 m²/g, at least 80 m²/g, about 70 m²/g, 80 to 200 m²/g, 90 to 150 m²/g, or 95 to 110 m²/g.

In some embodiments, the bed grading material has a pore volume of at least 0.1 cm³/g, at least 0.15 cm³/g, at least 0.17 cm³/g, 0.1 to 0.3 cm³/g, or 0.15 to 0.25 cm³/g.

In some embodiments, the bed grading material has an internal porosity of at least 70%, at least 73%, at least 75%, at least 78%, at least 80%, or greater than 80%.

In some embodiments, the bed grading material has a bulk density of 0.2 to 1.5 g/cm³, 0.3 to 0.9 g/cm³, or 0.35 to 0.7 g/cm³.

In some embodiments, the bed grading material has a loading density of less than 0.5 g/cm³, less than 0.4 g/cm³, less than 0.35 g/cm³, less than 0.3 g/cm³, or less than 0.25 g/cm³.

In some embodiments, the bed grading material has a basis weight of 5000 to 7000 g/m 2 or 6000 to 65000 g/m².

In some embodiments, the bed grading material has an axial strength of at least 100 lbs, at least 200 lbs, at least 300 lbs, or 100 to 350 lbs.

In some embodiments, the bed grading material comprises a total weight of silica and alumina (from all sources, i.e., from fibers and other ingredients, including the hardening agent) of at least 70 wt %, at least 75 wt %, at least 80 wt %, at least 85 wt %, or at least 90 wt %. In some embodiments, the bed grading material comprises a total weight of silica (from all sources) of 50 to 90 wt %, 60 to 80 wt %, or 70 to 80 wt %. In some embodiments, the bed grading material comprises a total weight of alumina (from all sources) of 5 to 80 wt %, 10 to 50 wt %, or 10 to 30 wt %.

In some embodiments, the bed grading material has a surface area per bulk density of at least 0.3 (m²/g)/(lb/ft³), at least 0.4 (m²/g)/(lb/ft³), at least 0.5 (m²/g)/(lb/ft³), at least 0.7 (m²/g)/(lb/ft³), at least 0.9 (m²/g)/(lb/ft³), at least 1 (m²/g)/(lb/ft³), at least 2 (m²/g)/(lb/ft³), at least 3 (m²/g)/(lb/ft³), 0.5 to 5 (m²/g)/(lb/ft³), 1 to 7 (m²/g)/(lb/ft³), 1.2 to 4.5 (m²/g)/(lb/ft³), 3 to 5 (m²/g)/(lb/ft³), 1 to 4 (m²/g)/(lb/ft³), or 3 to 4.5 (m²/g)/(lb/ft³). The high surface area per bulk density allows for a lighter bed grading layer (grading bed) while providing excellent available surface area.

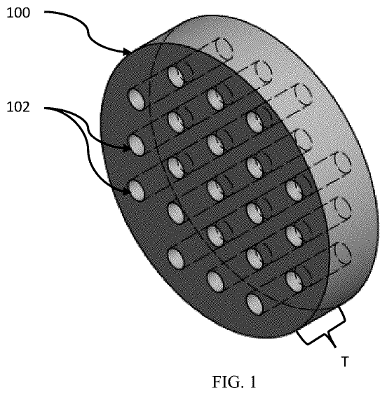

The shape, size, and mechanical properties of the bed grading material may be tailored to specifications of the reactor. Turning to FIG. 1, in some embodiments, the bed grading material 100 is a circular disc having a plurality of holes 102 drilled therethrough. In some embodiments, the circular disc has a diameter of 10 to 200 mm, 30 to 100 mm, or 40 to 50 mm. In other embodiments, the bed grading material 100 may be rectangular, hexagonal, polygonal, or irregularly shaped. In some embodiments, the bed grading material 100 has a thickness T of 5 to 100 mm, 5 to 50 mm, 5 to 20 mm, 10 to 15 mm, or about 10 mm. The holes 102 may provide additional surface area to the bed grading material 100 but are primarily used to create a desired pressure drop (dP) when the bed grading material is used to form a grading bed in a reactor. The pattern of the holes 102 is not particularly limited. In some embodiments, the bed grading material 100 does not include any holes 102.

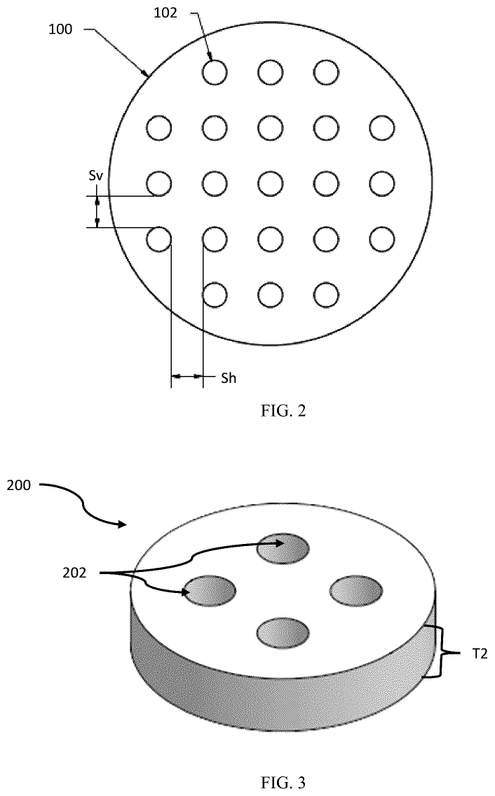

In some embodiments, as shown in FIG. 2, the holes 102 may have a vertical spacing Sv of 0.1 to 20 mm, 1 to 10 mm, 3 to 8 mm, or about 5 mm. Similarly, the holes 102 may have a horizontal spacing Sh of 0.1 to 20 mm, 1 to 10 mm, 3 to 8 mm, or about 5 mm. In some embodiments, the holes 102 have a diameter of 0.1 to 15 mm, 1 to 10 mm, 2 to 5 mm, or about 3.5 mm. In some embodiments, the holes 102 have varying diameters. Although a regular pattern is shown in FIG. 2, the holes 102 may be formed in any ordered or disordered pattern.

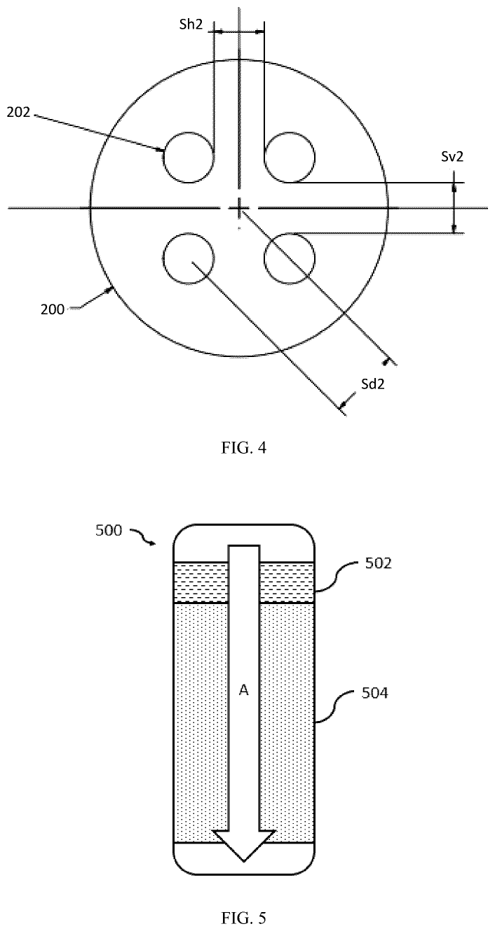

Turning to FIG. 3, another embodiment of the bed grading material 200 is shown comprising a plurality of holes 202 drilled therethrough. Although the bed grading material 200 is a circular disc, the shape is not so limited. The bed grading material 200 has a thickness T2, which may be the same as the thickness T described above. Referring to FIG. 4, the holes 202 may have a vertical spacing Sv2 of 0.1 to 20 mm, 1 to 15 mm, 3 to 10 mm, or about 8 mm. Similarly, the holes 202 may have a horizontal spacing Sh of 0.1 to 20 mm, 1 to 15 mm, 3 to 10 mm, or about 8 mm. Additionally, the holes 202 may each be spaced from a center of the bed grading material 200 by a spacing Sd2, which may be 5 to 30 mm, 8 to 15 mm, or about 11 mm. In some embodiments, the holes 202 have a diameter of 0.1 to 20 mm, 2 to 15 mm, 5 to 10 mm, or about 8 mm. In some embodiments, the holes 202 have varying diameters.

In some embodiments, the bed grading material may be vacuum formed, extruded, pressed, wet-laid, or 3D printed, or formed by other similar methods. In some embodiments, the bed grading material may be vacuum formed into a desired shape without any further processing. In some embodiments, the bed grading material may be formed from a board or other shaped piece that is then milled into a desired shape and size; pores may also be introduced into this material to customize the pressure drop of the material.

In some embodiments, the bed grading material is formed from a slurry of the fibers, binder, hardening agent, and a dispersing agent (such as water), wherein the dispersing agent is removed during drying of the bed grading material. Additional hardening agent may be impregnated into the bed grading material after drying. In such embodiments, a method of forming the bed grading material includes forming a slurry having a solid content comprising 5 to 85 wt %, 20 to 85 wt %, or 20 to 75 wt % fibers, 2 to 25 wt % or 5 to 25 wt % binder, and 5 to 30 wt % or 5 to 20 wt % silica. In some embodiments, the solid content comprises about 5 to 50 wt %, about 10 to 30 wt %, or about 20 wt % of the slurry, with the balance being water. The method may further include drawing the slurry into a cast or mold or wet-laying to remove the water and form a monolith to a desired density and thickness. The monolith may then be dried at a temperature of about 60 to 125° C.

Optionally, the monolith may be sanded and/or compressed to a desired thickness. The monolith may then be cut into a desired shape, such as a disc, and pores may also be introduced into the cut shape to create a suitable pressure drop. The shaped monolith may then be soaked in additional hardening agent, which may be the same or different from the hardening agent in the slurry, dried, and calcined at a temperature of about 500 to 800° C. to provide the bed grading material.

The bed grading material may optionally be catalyzed. In some embodiments, the catalyst may include copper, zinc, iron, nickel, molybdenum, oxides thereof, other transition metals or transition metal oxides, or combinations thereof. In some embodiments, catalyzing the bed grading material includes soaking the bed grading material in a catalyst solution, drying, and calcining. In some embodiments, catalyzing the bed grading material includes incorporating the catalyst into the slurry. In some embodiments, the catalyst may be both incorporated into the slurry and applied after the bed grading material has been formed and dried. Other suitable catalyzation methods known in the art may also be used.

Turning to FIG. 5, also provided herein is a reactor 500 comprising a bed grading layer 502 upstream of a catalyst bed 504. The bed grading layer 502 includes or may consist of the bed grading material disclosed herein. In some embodiments, the reactor 500 does not include a catalyst bed 504 or the catalyst bed 504 may be located in a separate vessel. The flow of fluid through the reactor 500 is shown by arrow A. Although the reactor 500 is depicted with a top-down flow, it may alternatively be configured to flow bottom-up, horizontally, or at an angle. In any orientation, the bed grading layer 502 may be positioned upstream of the catalyst bed 504.

When used in the reactor 500, the bed grading material may result in a similar or higher pressure drop (dP) as compared with traditional materials, though not unacceptably high. The increased dP suggests that more reactant stream (gas and/or liquid) is being forced through the pores of the bed grading material, thereby resulting in more efficient treatment or remediation of the reactant stream.

As will be further appreciated in the examples below, the bed grading material described herein is a high surface area, porous product that allows target reactions (e.g., capture of catalyst foulants or catalytic conversion) to occur within pores of the bed grading material. The bed grading material is less dense than traditional material, which allows for a much lighter bed grading laying. This feature allows for easier and safer installation of the bed grading layer in a reactor (e.g., sock loading), wherein large quantities of bed grading material may need to be lifted several to tens of meters high and positioned into the reactor. Further, the reduced weight of the bed grading layer beneficially exerts less pressure on the reactor layers below (e.g., a catalyst layer) as well as on the lower portions of the bed grading layer itself. Higher pressures within the reactor could result in materials cracking or breaking and/or the production of fines (e.g., particles or dust) all of which can negatively affect the operation of the reactor. For instance, breakage and/or production of fines can create hazards when loading or unloading the material, plug the reactor, and/or poison downstream reactors or processes.

Additionally, despite the lower density of the present bed grading material, it was found to produce fewer fines than traditional materials. This surprising effect is important due to the high stress placed on the bed grading materials during installation into, and operation of, the reactor. For example, during installation, the bed grading material may be dropped several feet into the reactor. Degradation of bed grading materials leads to issues within the reactor such as those described above and may require more frequent replacement of the bed grading material and/or repair of the reactor. Traditionally, strength is needed to avoid breakage and production of fines, but increasing strength often comes with lower porosity and/or pore volume. However, the present bed grading material is able to provide adequate strength and durability while maintaining very high porosity, pore volume, and active surface area.

### EXAMPLES

### Example 1

Ionically charged starch, 4-micron γ-alumina fiber (surface area of 120 m²/g), 6-micron α-alumina fiber (surface area of 1 m²/g), and cationically stabilized colloidal silica were mixed stepwise with water to form a slurry. Water was also added as needed between steps to achieve desired consistency. Table 1 below summarizes the solid content of the slurry.

TABLE 1

| | Weight (lb) | Solid Weight Percentage (%) |
|---|---|---|
| 4-micron fiber | 75 | 66% |
| 6-micron fiber | 22 | 19% |
| Starch | 8.5 | 8% |
| Colloidal Silica | 20 | 7% |

Note: the colloidal solution had 40 wt % of solids.

The slurry was vacuum formed into a monolith and dried. The monolith was then immersed in a rigidizing agent (hardening agent; cationically stabilized colloidal silica, alumina or titania) and dried and heat treated to provide an uncatalyzed bed grading material.

### Example 2

Discs of four bed grading materials were prepared according to the procedure of Example 1. Samples 1-3 were immersed in varying amounts of colloidal silica as the hardening agent, with the amount of colloidal silica increasing from Sample 1 to Sample 3. Sample 4 was immersed in colloidal alumina. Sample 3 was catalyzed by coating with a catalyst comprising molybdate.

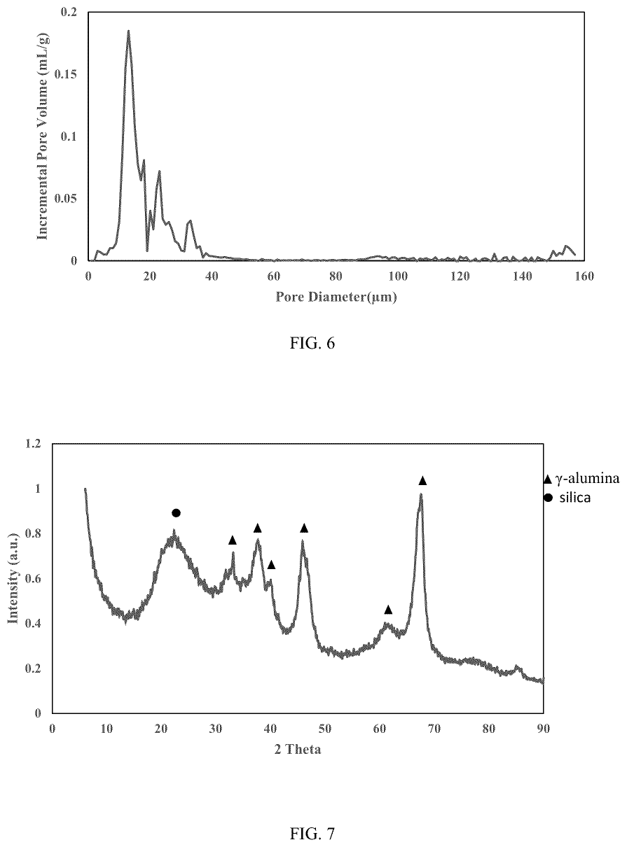

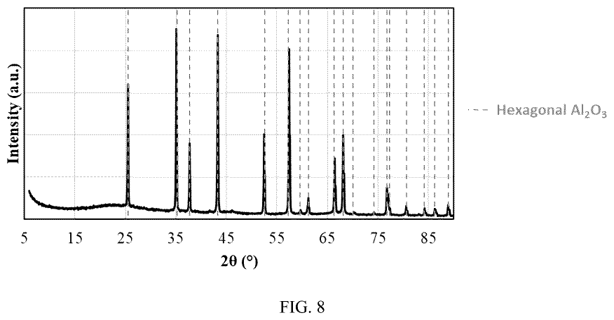

Samples 1-4 and a commercially available Comparative Sample 1 were examined for chemistry, porosity, crystallinity, surface area and other physical measurements. The results are summarized in Table 2 below. FIGS. 6 and 7 show the mercury intrusion porosity and XRD analysis of Sample 2. FIG. 8 shows the XRD analysis of Comparative Sample 1.

TABLE 2

| | Comp. | | | | |
|---|---|---|---|---|---|
| Physical Properties | Sample 1 | Sample 1 | Sample 2 | Sample 3 | Sample 4 |
| Color | Blue | Off-White | Off-White | Off- | Off-White |
| | | | | Green/Grey | |
| Disc Chemistry | Al₂O₃: 72% | Al₂O₃: 70% | Al₂O₃: 56% | Al₂O₃: 36% | Al₂O₃: 86.3% |
| | SiO₂: 24% | SiO₂: 30% | SiO₂: 43% | SiO₂: 59% | SiO₂: 13.1% |
| | CaO: 2% | Trace: <1% | Trace: <1% | MoO₃: 5% | Trace: <1% |
| | Trace: 2% | | | Trace: <1% | |
| Thickness, mm | 20 | 10 | 10 | 10 | 10 |
| Outside Diameter, mm | 45 | 47 | 47 | 47 | 47 |
| Alumina Phase | Crystalline | Gamma | Gamma | Gamma | Gamma |
| Axial Plate Crush | 300 | 100 | 150 | 300 | 250 |
| Strength, lbs | | | | | |
| Maximum Operating | 2000 | 2000 | 2000 | 2000 | 2000 |
| Temperature, ° F. | | | | | |
| Sock Loaded Density | 22 | 14 | 14 | 26 | 20 |
| (lbs/ft³) | | | | | |
| Bulk Density (lbs/ft³) | 37 | 24 | 27 | 42 | 34 |
| Internal Porosity, % | 80% | 84% | 81% | 73% | 74% |
| Porosity per Volume | 1.1 | 4.8 | 4.7 | 4.2 | 4.3 |
| (%/cc) | | | | | |
| Pore Volume (cc/g) | 0.01 | 0.22 | 0.21 | 0.12 | 0.31 |
| Effective Surface Area | 6.5 | 100 | 95 | 55 | 130 |
| for Capture, m²/g | | | | | |
| Surface Area per bulk | 0.18 | 4.2 | 3.5 | 1.3 | 3.8 |
| density ((m²/g)/(lb/ft³)) | | | | | |

All the discs of Samples 1-4 showed better porosity per volume as compared with the traditional material of Comparative Sample 1. As such, the discs of Samples 1-4 are able to provide better contact with the feed and greater area for pick up or conversion in a lighter and smaller form. The smaller volume and lower sock density means that more discs can be loaded into a vessel and the payload is lighter. More discs with more porosity means more activity per volume than the typical material. Without being bound by theory, these effects are believed to be due to the fibers used to form the bed grading material, which include gamma alumina and are at least in part amorphous in nature.

### Example 3

Ionically charged starch, 4-micron γ-alumina fiber (surface area of 120 m²/g), 6-micron α-alumina fiber (surface area of 1 m²/g), copper powder, and cationically stabilized colloidal silica were mixed stepwise with water to form a slurry. Water was also added as needed between steps to achieve desired consistency. Table 3 below summarizes the solid content of the slurry.

TABLE 3

| | Weight (g) | Solid Weight Percentage (%) |
|---|---|---|
| 4-micron fiber | 73 | 39% |
| 6-micron fiber | 20 | 10% |
| Starch | 13 | 7% |
| Copper Powder | 56 | 30% |
| Colloidal Silica | 64 | 14% |

Note: the colloidal solution has 40 wt % of solids.

The slurry was vacuum formed into a monolith or parts and dried. The monolith was then immersed in a hardening agent (cationically stabilized colloidal silica, alumina or titania) and dried and heat treated to provide an uncatalyzed bed grading material. The uncatalyzed bed grading material is able to be catalyzed further with an additional active agent.

Although various embodiments have been shown and described, the disclosure is not limited to such embodiments and will be understood to include all modifications and variations as would be apparent to one of ordinary skill in the art. Therefore, it should be understood that the disclosure is not intended to be limited to the particular forms disclosed; rather, the intention is to cover all modifications, equivalents, and alternatives falling within the spirit and scope of the disclosure as defined by the appended claims.

What is claimed is:

1. A bed grading material comprising:
inorganic fibers comprising alumina;
a hardening agent; and
a binder.

2. The bed grading material of claim 1, wherein the alumina is γ-alumina.

3. The bed grading material of claim 1, wherein the inorganic fibers comprise first fibers and second fibers, wherein the first fibers have a different surface area than the second fibers.

4. The bed grading material of claim 3, wherein the first fibers have a surface area of 50 to 200 m²/g and the second fibers have a surface area of less than 30 m²/g.

5. The bed grading material of claim 1, wherein the inorganic fibers comprise first fibers and second fibers, wherein the first fibers have a different diameter than the second fibers.

6. The bed grading material of claim 4, wherein the first fibers have a smaller diameter than the second fibers.

7. The bed grading material of claim 1, wherein the binder comprises starch, latex, polyvinyl chloride, an alcohol, an acrylamide, natural resins, synthetic resins, or combinations thereof.

8. The bed grading material of claim 1, wherein the inorganic fibers comprise at least 20 wt % based on a total weight of the bed grading material.

9. The bed grading material of claim 1, comprising at least one of:
a surface area of at least 50 m²/g;
a pore volume of at least 0.15 cm³/g; or
a bulk density of 0.3 to 1.5 g/cm³.

10. The bed grading material of claim 1, wherein the hardening agent comprises a colloidal metal oxide, wherein the metal oxide is silica, alumina, titania, zinc oxide, magnesia, zirconia, or combinations thereof.

11. The bed grading material of claim 1, comprising a surface area per bulk density of at least 0.5 (m²/g)/(lb/ft³).

12. A method comprising:
mixing inorganic fibers comprising alumina, a hardening agent, and a binder to form a mixture; and
forming the mixture into a bed grading material.

13. The method of claim 12, wherein the hardening agent comprises a colloidal metal oxide, wherein the metal oxide is silica, alumina, titania, zinc oxide, magnesia, zirconia, or combinations thereof.

14. The method of claim 12, wherein forming the mixture comprises wet-laying the mixture, vacuum-forming the mixture, extruding the mixture, or 3D printing the mixture.

15. The method of claim 12, wherein mixing the inorganic fibers comprises forming a slurry of the inorganic fibers, the hardening agent, and the binder.

16. The method of claim 12, further comprising impregnating the bed grading material with a second hardening agent that may be the same or different from the hardening agent used in the mixing step.

17. The method of claim 16, wherein the second hardening agent is colloidal silica and/or colloidal alumina.

18. The method of claim 12, further comprising coating a catalyst onto the bed grading material and/or wherein the mixing step further comprises mixing a catalyst with the inorganic fibers, the hardening agent, and the binder.

19. A grading bed comprising the bed grading material of claim 1.

20. A reactor comprising the grading bed of claim 19.
